(19) United States
(12) Patent Application Publication
(10) Pub. No.: US 2024/0261647 A1
(43) Pub. Date: Aug. 8, 2024

(54) A GRIP ADJUSTMENT SYSTEM AND METHOD

(71) Applicant: EATON INTELLIGENT POWER LIMITED, Dublin, 4 (IE)

(72) Inventors: Padhraig RYAN, Kilkenny, Keatingstown (IE); Daniel ZUCCHETTO, Dublin (IE); James RYLE, Dublin, Dublin 6 (IE); Daniel BROWNE, Dublin (IE); Mark KELLY, Dublin (IE)

(21) Appl. No.: 18/566,442

(22) PCT Filed: Jun. 2, 2021
(86) PCT No.: PCT/EP2021/064866

§ 371 Date: Dec. 1, 2023

(51) Int. Cl. A63B 60/30; A63B 53/14; A63B 60/14; A63B 60/46

(52) U.S. Cl. CPC A63B 60/30; A63B 53/14; A63B 60/14; A63B 60/46; A63B 2060/462; A63B 2060/464; A63B 2209/14

(57) ABSTRACT

A grip adjustment system comprising: a sleeve positionable, in use, on an object configured to be gripped by a user. The system also comprises a distributed array of actuators, each actuator being arranged to actuate a respective portion of the sleeve between a first position and a second position in response to an actuation signal; and a processor. The processor is operable to: receive a pressure distribution and an event quality indicator corresponding to an event of interest; determine an optimal grip based on the pressure distribution and the event quality indicator; select an actuator, of the distributed array of actuators, to be actuated based on the optimal grip; transmit the actuation signal to the actuator such that the shape of the sleeve is changed and the grip of the user is adjusted.

### FIELD OF THE DISCLOSURE

The present disclosure relates to a grip adjustment system and method and finds particular, although not exclusive, utility in a system and method for adjusting a grip of an athlete, such as a golfer, using sports equipment, such as a golf club.

### BACKGROUND TO THE DISCLOSURE

One of the most important factors affecting the performance of athletes in club, bat or racket based sports is the athlete's grip on their club, bat or racket. Minor changes in grip position and force can have a significant impact on the outcome of a shot or other sporting action. For example, in golf, a shot taken with a minor change in a golfer's grip, such as a 1º change in angle around the shaft, may result in at least a metre change in position of the ball after the shot. Golfers, along with other athletes, may vary their grip depending on their desired shot outcome. Typically, athletes understand that altering their grip will alter the shape, flight and distance of their shot. Some athletes may aim to use a highly consistent grip placement and force whilst altering some other aspect of their swing. For a right-handed golfer, a swing with a so-called strong grip, which is a term used to describe a grip in which the golfer's left thumb and index finger align with their shoulder and/or neck when addressing a shot, may result in the ball travelling further left than the same swing made with a so-called neutral or weak grip. A strong grip is also understood to close a clubface and effectively reduce the loft of the club, resulting in a shot that flies lower and travels further when compared to a shot made with a neutral or weak grip. Accordingly, the athlete's grip has a large impact on the shot outcome.

Typically, athletes receive feedback on their grip, and the resulting shot, through coaching or practice, often including video feedback. However, the athlete's grip is not the only factor that affects the outcome of their shot. For example, the swing path of a golf shot and environmental factors such as wind also have a significant effect on the outcome of the shot. As there are many factors affecting shot outcomes and small changes in the athlete's grip can have a large impact on the shot outcome, it is difficult for inexperienced athletes and coaches to correctly diagnose and fix grip faults. Furthermore, even elite level athletes and coaches may find it difficult to correctly diagnose and fix grip faults.

Therefore, it is desirable to provide a grip adjustment system and method capable of adjusting a user's grip on an object. Objects and aspects of the present disclosure seek to provide such a system and method.

### SUMMARY OF THE DISCLOSURE

In accordance with a first aspect of the present disclosure, there is provided a grip adjustment system comprising: a sleeve positionable, in use, on an object configured to be gripped by a user; a distributed array of actuators, each actuator being arranged to actuate a respective portion of the sleeve between a first position and a second position in response to an actuation signal; and a processor operable to: receive a pressure distribution and an event quality indicator corresponding to an event of interest; determine an optimal grip based on the pressure distribution and the event quality indicator; select an actuator, of the distributed array of actuators, to be actuated based on the optimal grip; transmit the actuation signal to the actuator such that the shape of the sleeve is changed and the grip of the user is adjusted.

In the context of the present disclosure, the term “event of interest” will be understood by the skilled addressee as referring to an event during a session in which it is useful to adjust a grip of a user. For example, in a session of golf, the event of interest may be when a golf shot occurs.

Alternatively, the event of interest may be a propelling action during skiing, in which a threshold grip strength is required to apply a force to the ground via the ski pole without losing grip of the ski pole.

A user may manually tag an event of interest. Alternatively, an algorithm may be used to identify when an event of interest takes place. Accordingly, the event of interest may be determined without a user manually tagging the input data.

In the context of the present disclosure, the term “event quality indicator” will be understood by the skilled addressee as referring to a quality of the event of interest. For example, in the case of a session of golf, the event quality indicator may be determined by a speed of a golf ball during a golf shot, or the accuracy of the golf shot. The event quality indicator may be a numerical value. Alternatively, the event quality indicator may be represented by any suitable representation. The optimal grip may be determined based on an event quality indicator that meets an event quality threshold. Advantageously, the optimal grip may be based on a higher quality output result of the event of interest (e.g. a golf shot).

In the context of the present disclosure, the term “optimal grip” will be understood by the skilled addressee as referring to a grip which leads to a highest quality of the event of interest. The “grip” will be understood as referring to a hand alignment of a user.

A key advantage of the present disclosure is that the system may provide a user with assistance in various activities by guiding the user's fingers and/or palms to a desirable position on the object. The desirable position may improve the user's efficiency and/or power when using the object.

The processor may be operatively connected to the array of actuators. Accordingly, the processor may be able to communicate with the array of actuators. The processor may be adjacent to the sleeve. Alternatively, the processor may be spaced and separate from the sleeve. The processor may be an edge computing device.

The grip adjustment system may further comprise a rechargeable battery configured to supply power to the processor. Alternatively, or additionally, the grip analysis system may comprise a non-rechargeable battery configured to supply power to the processor. Alternative power storage devices, such as supercapacitors, are envisaged.

The array of actuators may comprise at least 8 actuator elements. The array of actuators may be arranged in an 8×1 grid pattern. The array of actuators may comprise at least 368 actuator elements. The array of actuators may be arranged in an 8×46 grid pattern. The array of actuators may comprise at least 1000 actuators. The actuators may be provided at a density of at least 1 actuator per square centimetre, preferably at least 2 actuators per square centimetre, more preferably at least 4 actuators per square centimetre. Each actuator element may have a size of approximately 0.5 centimetres by 0.5 centimetres. Accordingly, providing 4 actuators per square centimetre at a size of 0.5 centimetres by 0.5 centimetres may cover the entire area with actuator elements. Other actuator element sizes and densities are envisaged. The array of actuators may be arranged in a regular grid pattern. Alternatively, the array of actuators may be arranged in an irregular grid pattern. Accordingly, more actuators may be provided in the regions of the sleeve which are more likely to be gripped by the user. For example, if the sleeve is a golf grip, it is likely that the user will grip the sleeve in a middle portion away from the extreme ends of the grip. Therefore, more actuators may be provided in the middle portion of the grip.

The object may be a golf club. The sleeve may be golf club grip. The event of interest may be a golf shot. Accordingly, a grip applied by a user's fingers and/or palm to the golf club may be adjusted by the grip adjustment system.

Alternatively, the object may be another piece of sports equipment, such as a ski pole, a baseball bat, a tennis racket, a badminton racket, a cricket bat, a hockey stick, a hurley, a lacrosse stick, a table tennis paddle, a fishing rod, or any other known sports equipment configured to be held by a user. Accordingly, a user may have their grip adjusted for any piece of sports equipment that requires an optimal finger and/or palm placement.

Alternatively, the object may be a piece of non-sporting equipment, such as a steering wheel, a trolley handle, a mobile phone, a kitchen knife, a screwdriver or any other known piece of non-sporting equipment configured to be held by a user. Accordingly, a user may have their grip adjusted for any piece of non-sporting equipment that requires an optimal finger and/or palm placement. Further alternatively, the object may be a tool. A user may grip the tool to operate it. The sleeve may be a grip on the tool intended to be held by the user. The user may find that a particular grip results in improved operation of the tool. For example, a user may find that they are more likely to drill a hole in a straight line with minimal damage to surrounding materials by using one particular grip, when compared to another grip the user may use. Alternatively, the tool may be a craft tool, such as a craft knife or a tool used in carpentry. A user may find that they are able to achieve more preferable results when using the craft tool with a certain grip, and the system may be used to adjust their grip. Accordingly, the system may be used to adjust the grip of the user to the grip which provides the more preferable results.

Preferably, the grip adjustment system further comprises a remote server configured to store: the pressure distribution; the event quality indicator; and a predetermined optimal grip; and a computing device in communication with the remote server and the processor. The remote server may be a cloud-based server. The computing device may be a smart phone. Accordingly, the processor may access the remote server via the computing device. A database of pressure distributions and event quality indicators may be built up over time and stored on the remote server, which may advantageously be used to improve the accuracy of the optimal grip determination.

In the context of the present disclosure, the term “predetermined optimal grip” will be understood by the skilled addressee as referring to a pre-existing grip. For example, the pre-existing grip may be a known grip used by a professional golf player. The pre-existing grip may be downloaded to the remote server or to a local processor from an external database.

Preferably, the pressure distribution comprises: a pressure magnitude; and a sleeve position; wherein the pressure magnitude corresponds to the sleeve position. In this way, the pressure distribution may indicate the position of the user's fingers and/or palm and a force applied at each position.

The event quality indicator may be determined by one selected from the range of: an external quality measurement system; and an event quality tag. The external quality measurement system may be a radar shot-tracking device configured to track a speed and accuracy of a golf shot. The external quality measurement system may be operatively connected to the processor. The external quality measurement system may be in communication with the remote server and/or the computing device. The external quality measurement system may also be a device attached to the tool, such as a gold club. For example, the measurement system may comprise one or more selected from the range of: an accelerometer; a gyroscope; a magnetometer. In this way, the speed, tempo, angle, and direction of the event of interest may be monitored. Accordingly, the event quality indicator may be determined objectively. The event quality tag may be manually applied by a user via the computing device. For example, the user may take a golf shot and then rate the golf shot on a scale of 1 to 10, thereby indicating the quality of the golf shot. Alternative event quality tags are envisaged. Accordingly, the event quality indicator may be determined subjectively.

Preferably, the actuators are microactuators. The microactuators may be one or more selected from the range of: an electrostatic microactuator; an electromagnetic microactuator; a piezoelectric microactuator; a fluid microactuator; and a thermal microactuator. Alternatively, the microactuators may be any device suitable for converting one form of energy into motion. In this way, the microactuators may adjust a radius of the sleeve on a micrometre and/or millimetre scale. The microactuators may be micro-machines, micro-robots or any suitable micro-device.

Preferably, the actuators are adjacent to an interior surface of the sleeve. In this way, motion generated by the actuators may be applied to the interior surface of the sleeve. Each actuator preferably corresponds to a respective portion of the sleeve. A surface of the actuator may be attached to the interior surface of the respective portion of the sleeve. The actuator may be attached to the interior surface via an adhesive. Additional attachment means are envisaged. The sleeve may impart an inward pressure to the actuators as a result of a tightness of the sleeve on the object.

The actuators may comprise a polyelectrolyte gel actuator material. Alternatively, the actuators may comprise a polymer gel actuator material. In this way, the actuators may change shape in response to a stimulation. Advantageously, the change in shape of an actuator may result in a change in a radial displacement of a respective portion of the sleeve.

Further alternatively, the actuators may comprise one selected from the range of: a shape-memory polymer actuator material an electrostatic microactuator; an electromagnetic microactuator; a piezoelectric microactuator; a fluid microactuator; and a thermal microactuator. In this way, the actuators may transition from an original shape to a deformed shape. The deformed shape may result in a radial increase which in turn may cause a radial increase of the sleeve. In some embodiments, the radial increase may be 1 mm.

Preferably, the second position comprises a greater radial displacement than the first position, relative to a central axis of the sleeve. In this way, when the actuator actuates the respective portion of the sleeve from the first position to the second position, the radius increases. It shall be appreciated by the skilled addressee that the actuator may also reduce radial displacement of the respective portion of the sleeve.

In some embodiments, the actuators are each configured to alternate between a first size and a second size. In this way, the actuator may influence the radial displacement of the respective portion of the sleeve by changing between the first size and the second size. The actuator may increase the radius of the system, or decrease the radius of the system, depending on the electrical signal received from the processor or microcontroller. Accordingly, a physical depth of an impression at an end of the user's fingers or hands may be increased. For example, the actuators may be depressed at a position where the user's hands or fingers are intended to be placed, and are expanded at the surrounds positions, thereby increasing the relative difference in the depth of the sleeve. Preferably, the first size of the actuator corresponds to the first positon of the respective portion of the sleeve and the second size corresponds to the second position of the respective portion of the sleeve.

In some preferable embodiments, each actuator comprises a microcontroller in communication with the processor. Accordingly, each actuator may be controlled by a respective microcontroller. Advantageously, greater control of the actuators may be achieved.

The microcontroller may be configured to receive the actuation signal from the processor; and transmit a stimulation signal to the actuator. Accordingly, the microcontroller may cause the actuator to alternate between the first position and the second position.

Alternatively, the actuators may all be in communication with a central microcontroller. In this way, all actuators may be controlled by a single microcontroller. Advantageously, simplicity of the system may be increased and production costs of the system may be reduced.

Each microcontroller may comprise a rechargeable battery configured to supply power to the microcontroller. Alternatively, or additionally, the microcontroller may comprise a non-rechargeable battery configured to supply power to the microcontroller. Alternative power storage devices, such as supercapacitors, are envisaged.

The stimulation signal may be an electrical current or voltage. In this way, the microcontroller may transmit the electrical current to the actuator which in turn may change shape in response to the electrical current.

The optimal grip may be determined using one selected from the range of: Pearson correlation; Chi-squared analysis; regression analysis; artificial neural network analysis; and decision tree analysis. Alternatively, any algorithm may be used that correlates the nature of the grip with the quality of the event. In this way, the optimal grip may be inferred based on a probability of a high quality event based on the pressure distribution and event quality indicator. Preferably, a plurality of pressure distributions and corresponding event quality indicators are used. Advantageously, an accuracy of the optimal grip determination may be increased.

In some embodiments, the pressure distribution is determined using a grip analysis system comprising: a sheath positionable, in use, on the object configured to be gripped by the user; a distributed array of pressure sensors, each comprising an array position, arranged to detect the pressure distribution applied to the sheath; and a processor operable to: detect, with the array of pressure sensors, a grip of a user on the sleeve; analyse the grip of the user on the sheath by: receiving input data from the array of pressure sensors; determining the pressure distribution corresponding to the grip of the user on the sheath based on the input data; and output the pressure distribution corresponding to the grip of the user on the sheath based on the input data.

The processor may be configured to separate the input data into a plurality of input data subsets. The processor may be configured to attribute each input data subset to a portion of a user's hand with multiclass classification. The processor may be configured to identify a position of each user hand portion on the sleeve based on the input data subset attributed to each user hand portion. The processor may be configured to compare the identified positions of each user hand portion to a predetermined desired position of each hand portion in order to identify a difference between the identified positions of each user hand portion and the predetermined desired position of each hand portion.

The processor may be operatively connected to the array of pressure sensors. Accordingly, the processor may be able to communicate with the array of pressure sensors. The processor may be adjacent to the sleeve. Alternatively, the processor may be spaced and separate from the sleeve. The processor may be an edge computing device.

The grip analysis system may further comprise a rechargeable battery configured to supply power to the processor. Alternatively, or additionally, the grip analysis system may comprise a non-rechargeable battery configured to supply power to the processor. Alternative power storage devices, such as supercapacitors, are envisaged.

The array of pressure sensors may comprise at least 8 pressure sensor elements. The array of pressure sensors may be arranged in an 8×1 grid pattern. The array of pressure sensors may comprise at least 368 pressure sensor elements. The array of pressure sensors may be arranged in an 8×46 grid pattern. The array of pressure sensors may comprise at least 1000 sensors. The sensors may be provided at a density of at least 1 sensor per square centimetre, preferably at least 2 sensors per square centimetre, more preferably at least 4 sensors per square centimetre. Each sensor element may have a size of approximately 0.5 centimetres by 0.5 centimetres. Accordingly, providing 4 sensors per square centimetre at a size of 0.5 centimetres by 0.5 centimetres may cover the entire area with sensor elements.

Other sensor element sizes and densities are envisaged. The array of pressure sensors may be arranged in a regular grid pattern. Alternatively, the array of pressure sensors may be arranged in an irregular grid pattern. Accordingly, more sensors may be provided in the regions of the sleeve which are more likely to be gripped by the user. For example, if the sleeve is a golf grip, it is likely that the user will grip the sleeve in a middle portion away from the extreme ends of the grip. Therefore, more sensors may be provided in the middle portion of the grip.

The pressure sensors may be one or more selected from the range of: a strain gauge; a resistive sensor; a piezoelectric sensor; a pneumatic sensor; a hydraulic sensor; and a fiber bragg grating. It will be appreciated by the skilled addressee that any suitable pressure sensor may be envisaged.

In some embodiments, the grip analysis system and the grip adjustment system may both be comprised in a single sleeve. In this case, the pressure distribution may be recorded and the optimal grip may be determined in response to the recording in real time.

In accordance with a second aspect of the present disclosure, there is provided a grip adjustment method comprising the steps of: receiving, from a remote server, a pressure distribution; determining, with a processor, an optimal grip based on the pressure distribution; selecting, with the processor, an actuator of a distributed array of actuators; transmitting, with the processor, an actuation signal to the actuator; actuating, with the actuator, a portion of a sleeve from a first position to a second position.

The grip adjustment method may include each or every step carried out during operation of the processor of the grip adjustment system. Accordingly, each grip adjustment system feature of the first aspect may be included in the second aspect of the present disclosure.

In accordance with a third aspect of the present disclosure, there is provided a grip analysis method comprising the steps of: detecting, by an array of pressure sensors, a grip of a user on a sheath; analysing the grip of the user on the sleeve by: receiving input data from the array of pressure sensors; determining a pressure distribution corresponding to the grip of the user on the sheath based on the input data; and outputting the pressure distribution corresponding to the grip of the user on the sheath.

The grip analysis method may include each or every step carried out during operation of the processor of the grip analysis system. Accordingly, each grip analysis system feature of the first aspect may be included in the third aspect of the present disclosure.

### BRIEF DESCRIPTION OF THE DRAWINGS

FIG. 1a is a schematic view of a grip adjustment system;

FIG. 1b is a perspective view of the grip adjustment system of FIG. 1a;

FIG. 2 is a schematic view of a grip analysis system;

FIG. 3 is a flow diagram showing a method of determining a grip quality indicator using the grip analysis system of FIG. 2;

FIG. 4a is a flow diagram showing a method for adjusting a grip of a user using the grip adjustment system of FIGS. 1a and 1b; and

FIG. 4b is a side view of an adjustable grip portion in use with the method of FIG. 4a.

### DETAILED DESCRIPTION

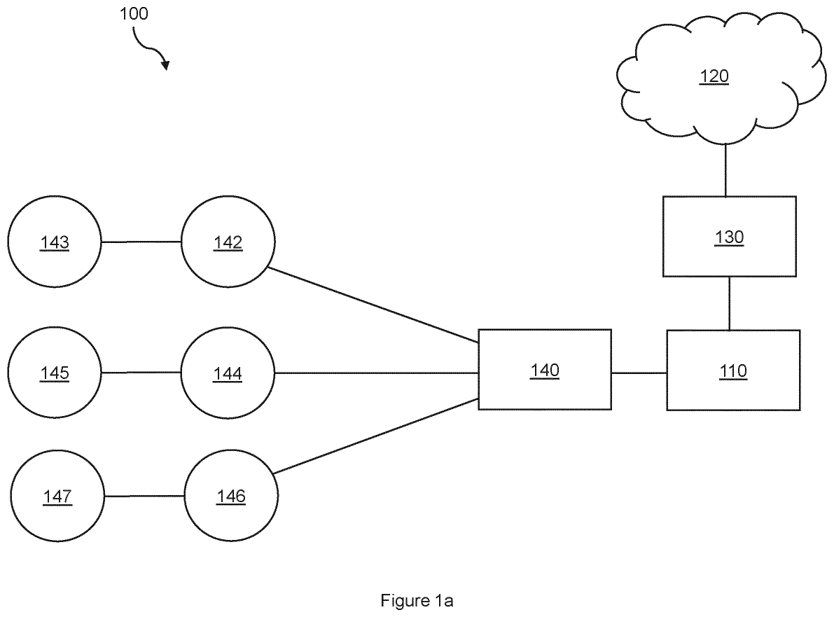

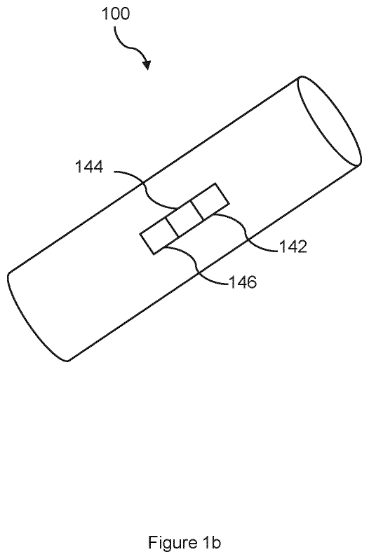

FIG. 1a is a schematic view of a grip adjustment system 100. The system 100 includes a processor 110 that is in communication with a cloud-based server 120 via a smart device 130. The processor 110 may be physically or wirelessly connected to the smart device 130 such as a smart phone or a smart watch. For example, the processor 110 and smart device 130 may communicate wirelessly via WiFi or Bluetooth.

The grip adjustment system 100 also includes an array of microactuators 140, each comprising a microcontroller that is in communication with the processor 110. The array of microactuators are shown schematically by microactuator elements 142, 144, 146, each having a respective microcontroller 143, 145, 147. Although only three microactuator elements 142, 144, 146 are shown, any number of microactuator elements may be provided. For example, 368 microactuator elements may be provided in a grid pattern. The array of microactuators 140 is configured to be arranged on an object to be gripped by a user, such as a golf club. In this case, the array of microactuators 140 may be on, under or embedded in the grip of the golf club or any other connected location. Each microactuator element 142, 144, 146 is operable, in response to an electric current, to actuate a corresponding portion of the grip of the golf club. Each microactuator element 142, 144, 146 comprises a microcontroller 143, 145, 147, a power source, and a polymer gel material. Alternatively, any material whose dimensions can be induced to change may be selected. The polymer gel material is configured to allow the respective microactuator element 142, 144, 146 to change in size in response to an electrical current. Alternatively, the microactuators 142, 144, 146 may be connected to a central power source.

Furthermore, the grip adjustment system 100 also includes a visual feedback device (not shown). Other types of feedback device are envisaged such as an audible feedback device or a haptic feedback device.

The processor 110 is operable to receive a grip quality indicator from the cloud-based server 120, determine an optimal grip, and transmit an actuation signal to the microcontrollers 143, 145, 147. The microcontrollers 143, 145, 147 are operable to receive the actuation signal from the processor and transmit an electrical current to the respective microactuators 142, 144, 146.

Turning now to FIG. 1b, there is shown a perspective view of the grip adjustment system 100 comprising the microactuator elements 142, 144, 146. The microactuator elements 142, 144, 146 are adjacent to an interior surface of the grip adjustment system 100.

Whilst the grip adjustment system 100 is depicted as comprising a cylindrical shape, it shall be appreciated that the grip adjustment system 100 may comprise any shape suitable for use with a grip of an object.

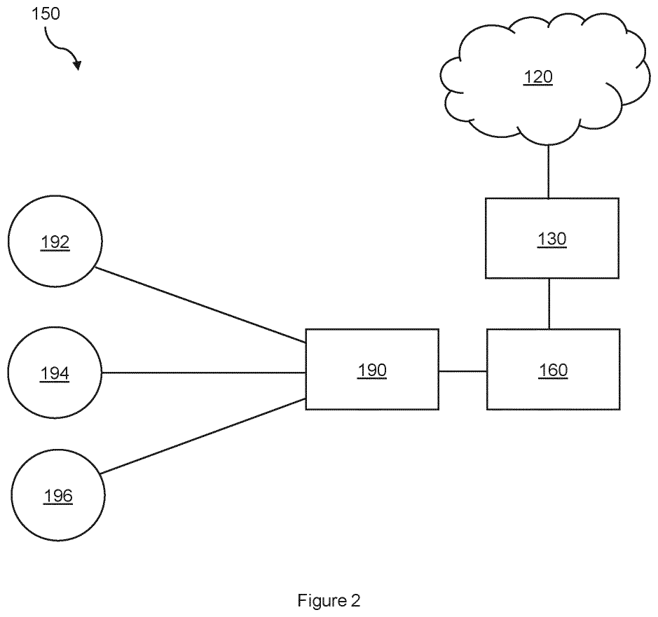

FIG. 2 is a schematic view of a grip analysis system 150. The system 150 includes a processor 160 that is in communication with the cloud-based server 120 via the smart device 130. The processor 160 may be physically or wirelessly connected to the smart device 130. For example, the processor 160 and smart device 130 may communicate wirelessly via WiFi or Bluetooth.

The grip analysis system 150 also includes an array of pressure sensors 190, shown schematically by sensor elements 192, 194, 196. Although only three sensor elements 192, 194, 196 are shown, any number of sensor elements may be provided. For example, 368 sensor elements may be provided in a grid pattern. The array of pressure sensors 190 is configured to be arranged on an object to be gripped by a user, such as a golf club. In this case, the array of pressure sensors 190 may be on, under or embedded in the grip of the golf club or any other connected location. Each sensor element 192, 194, 196 is operable to provide pressure data to the processor 110. Each sensor element 192, 194 196 is also operable to provide an array position indicative of a position of each sensor element 192, 194, 196 on the sensor array 190.

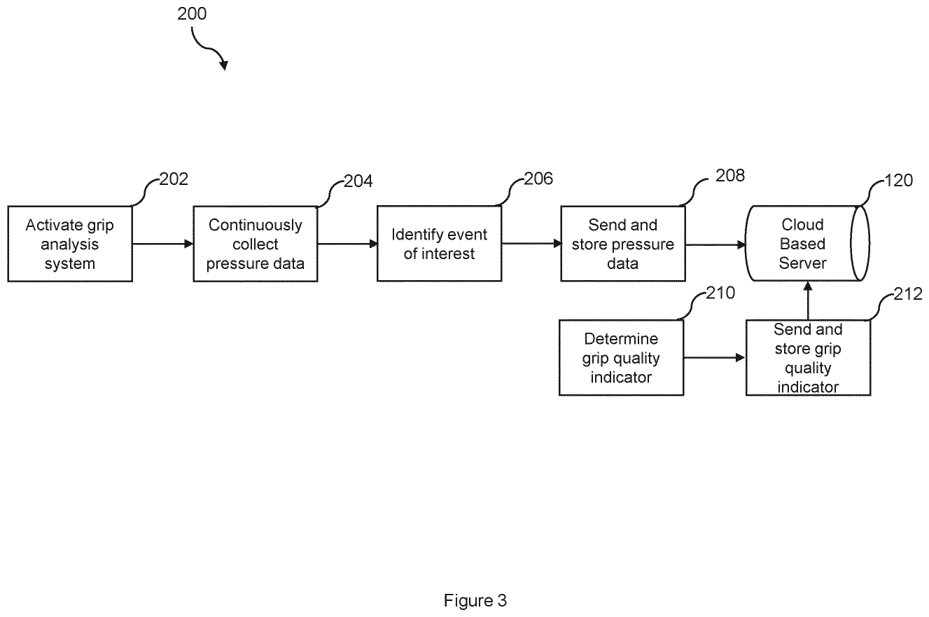

The processor 160 is operable to receive pressure data from the array of pressure sensors 190, process the pressure data with a method, to be discussed in more detail with reference to FIG. 3, to obtain a grip quality indicator. The visual feedback device may be operable to display the grip quality indicator.

FIG. 3 is a flow diagram 200 showing an in use method of determining a grip quality indicator and a pressure distribution of a grip of a user using the grip analysis system 150 of FIG. 1b. In this embodiment, the object to be gripped by the user is a golf club.

The first step, 202 of the method 200 is to activate the grip analysis system 150. The grip analysis system 150 may be activated automatically in response to a user taking a hold of the golf club in a grip and thereby applying a pressure to the sensor array 190. Alternatively, the sensor array 190 may be activated by a switch (not shown) or other activating device. The switch may be operated by the user in order to signify the start of an activity.

At step 204, the processor 160 continuously collects pressure data from the sensor array 190. The processor 160 also collects array positions associated with each sensor element 192, 194, 196. Accordingly, the pressure data may be associated with an array position corresponding to the respective sensor element 192, 194, 196.

At step 206, the processor 160 identifies that an event of interest has taken place. The event of interest may be a golf shot. The event of interest may be determined by collects acceleration data from an accelerometer (not shown) The acceleration data may be indicative of the golf club accelerating, for example during a golf shot. The processor 160 may determine that the acceleration data exceeds a predetermined acceleration threshold. The predetermined acceleration threshold may be any suitable acceleration threshold selected by the user. Alternatively, an algorithm may be used to determine a predetermined acceleration threshold based on previous acceleration data collected from the user. In response to the determination that the predetermined acceleration threshold has been met, the processor 160 may identify that an event of interest has taken place. Alternatively, the user may manually tag pressure data as being associated with an event of interest using the smart device 130.

At step 208, the processor 160 sends and stores the pressure data and the array positions captured during the event of interest to the cloud-based server 120. Accordingly, a position and force applied by each pressure-applying element, such as each finger, finger portion and/or palm portion, may be determined.

At step 210, the grip quality indicator is determined. The grip quality indicator is determined by measuring a shot speed and/or accuracy of the shot using external equipment, such as a radar shot-tracking device (not shown). Accordingly, the grip quality indicator may comprise continuous data such as shot speed. Alternatively, the grip quality indicator may be manually input by the user via the smart device 130. For example, the smart device 130 may be used to categorise the golf shot as “high quality” or a “desirable” shot.

At step 212, the processor 160 sends to and stores in the cloud-based server 120, the grip quality indicator.

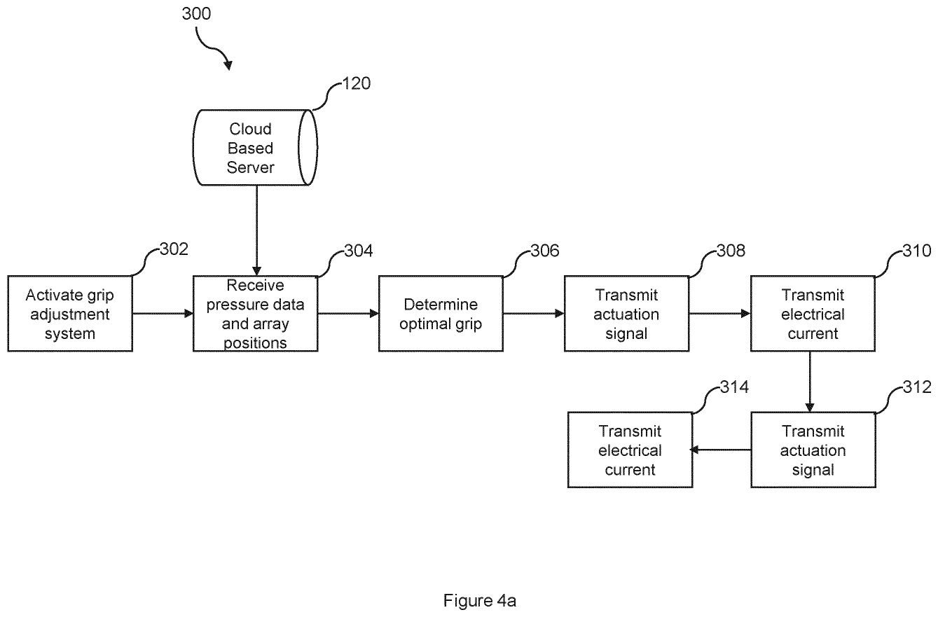

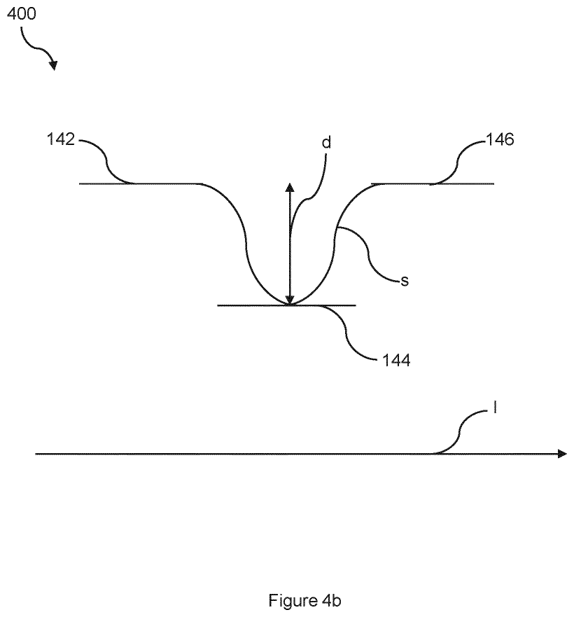

Turning now to FIG. 4a, a flow diagram for an example grip adjustment method is shown.

The first step, 302 of the method 300 is to activate the grip adjustment system 100. The grip adjustment system 100 may be activated by a switch (not shown) or other activating device. The switch may be operated by the user in order to signify the start of an activity.

At step 304, the processor 110 receives the pressure data and the array positions associated with the event of interest from the cloud-based server 120.

At step 306, the processor 110 determines an optimal grip. In particular, the processor determines an optimal hand placement and an optimal grip pressure. The optimal hand placement and grip pressure is determined using statistical processes such as Pearson correlation if continuous data is used (e.g. shot speed) or Chi-squared analysis if the golf shot has been categorised. The statistical processes identify a probability of a “high quality” golf shot occurring for various configurations of hand placement and grip pressure. The optimal grip is the configuration comprising the greatest probability of a “high quality” golf shot.

At step 308, the processor 110 transmits an actuation signal to the microcontrollers 143, 145, 147. The actuation signal is representative of the optimal grip and comprises instructions of which of the microactuator elements 142, 144, 146 are to be actuated.

Alternatively, the cloud-based server 120 may comprise a predetermined grip. The predetermined grip may be a grip inputted by the user, or downloaded from an external database. For example, the predetermined grip may comprise a hand placement and grip pressure used by a professional golf player. Accordingly, the user may emulate the professional golf player's grip. In this case, the processor 110 may transmit an actuation signal representative of the predetermined grip to the microcontrollers 145, 147,149.

In the present example, optimal grip comprises a hand placement having a portion of the user's index finger at a position corresponding to the microactuator element 144. Accordingly, the actuation signal comprises a first actuation signal, a second actuation signal and a third actuation signal. The first actuation signal comprises instructions to actuate the microactuator element 142. The second actuation signal comprises instructions to actuate the microactuator element 144. The third actuation signal comprises instructions to actuate the microactuator element 146. In particular, the first actuation signal comprises instructions to expand the microactuator element 142, the second actuation signal comprises instructions to compress the microactuator element 144, and the third actuation signal comprises instructions to expand the microactuator element 146,

FIG. 4b depicts a side view of an adjustable grip portion 400 with respect to the longitudinal axis I, in use with step 310. The adjustable grip portion 400 comprises a sleeve portion s, and the actuator elements 142, 144, 146.

At step 310, and with reference to FIG. 4b, the microcontrollers 143, 145, 147 transmit an electrical current to the respective microactuator elements 142, 144, 146. In particular, the microcontroller 143 transmits an electrical current to the microactuator element 142, causing the microactuator element 142 to increase in size along an axis orthogonal to a longitudinal axis of the sleeve portion s by 3 mm. A radius of the sleeve portion s at the position of the microactuator element 142 is increased by 3 mm. The microcontroller 145 transmits an electrical current to the microactuator element 144, causing the microactuator element 144 to decrease in size along the axis orthogonal to the longitudinal axis by 2 mm. The radius of the sleeve portion s at the position of the microactuator element 144 is decreased by 2 mm. Finally, the microcontroller 147 transmits an electrical current to the microactuator element 146, causing the microactuator element 146 to increase in size along the axis orthogonal to the longitudinal axis of the sleeve by 3 mm. The radius of the sleeve portion s at the position of the microactuator element 146 is increased by 3 mm. Accordingly, an indent d centred on the position of the microactuator element 144 is formed with a depth of 5 mm. The indent may guide the user's index finger to the position of the micro actuator element 144.

At step 312, the processor 110 transmits an actuation signal to the microcontrollers 143, 145, 147. The actuation signal is representative of the grip returning to its original shape.

At step 314 the microcontrollers 143, 145, 147 transmit an electrical current to the respective microactuator elements 142, 144, 146. In particular, the microcontroller 143 transmits an electrical current to the microactuator element 142, causing the microactuator element 142 to decrease in size along an axis orthogonal to a longitudinal axis of the sleeve portion s by 3 mm. The radius of the sleeve portion s at the position of the microactuator element 142 is decreased by 3 mm. The microcontroller 145 transmits an electrical current to the microactuator element 144, causing the microactuator element 144 to increase in size along the axis orthogonal to the longitudinal axis by 2 mm. The radius of the sleeve portion s at the position of the microactuator element 144 is increased by 2 mm. Finally, the microcontroller 147 transmits an electrical current to the microactuator element 146, causing the microactuator element 146 to decrease in size along the axis orthogonal to the longitudinal axis of the sleeve by 3 mm. The radius of the sleeve portion s at the position of the microactuator element 144 is decreased by 3 mm. Accordingly, the microactuator elements 142, 144, 146 have returned to their original size and the radius of the sleeve portion s is returned to the original radius.

It shall be noted that, in the above example, the actuation signal was only sent to the microactuators 142, 144, 146 in order to re-shape the golf grip and direct the user's index finger to the desired location. However, the skilled person will appreciate that there may be more than three microactuators required in order to re-shape the golf grip to a desirable shape. In addition, the skilled person will appreciate that the reshaping isn't limited to the user's index finger but may also applied to the other components of the user's hands, such as the user's other fingers and palms.

1. A grip adjustment system comprising:
a sleeve positionable, in use, on an object configured to be gripped by a user;
a distributed array of actuators, each actuator being arranged to actuate a respective portion of the sleeve between a first position and a second position in response to an actuation signal; and
a processor operable to:
receive a pressure distribution and an event quality indicator corresponding to an event of interest;
determine an optimal grip based on the pressure distribution and the event quality indicator;
select an actuator, of the distributed array of actuators, to be actuated based on the optimal grip;
transmit the actuation signal to the actuator such that the shape of the sleeve is changed and the grip of the user is adjusted.

2. The grip adjustment system of claim 1, wherein the object is a golf club, the sleeve is a golf club grip and the event of interest is a golf shot.

3. The grip adjustment system of claim 1, further comprising:
a remote server configured to store:
the pressure distribution;
the event quality indicator; and
a predetermined optimal grip;
a computing device in communication with the remote server and the processor.

4. The grip adjustment system of claim 1, wherein the pressure distribution comprises:
a pressure magnitude; and
a sleeve position;
wherein the pressure magnitude corresponds to the sleeve position.

5. The grip adjustment system of claim 1, wherein the event quality indicator is determined by one selected from the range of:
an external quality measurement system; and
an event quality tag.

6. The grip adjustment system of claim 1, wherein the actuators are microactuators.

7. The grip adjustment system of claim 1, wherein the actuators are adjacent to an interior surface of the sleeve.

8. The grip adjustment system of claim 1, wherein the actuators comprise an actuator material selected from the range of:
a polyelectrolyte gel;
a polymer gel;
a shape-memory polymer material;
an electrostatic microactuator;
an electromagnetic microactuator;
a piezoelectric microactuator;
a fluid microactuator; and
a thermal microactuator.

9. The grip adjustment system of claim 1, wherein the second position comprises a greater radial displacement than the first position, relative to a central axis of the sleeve.

10. The grip adjustment system of claim 1, wherein the actuators are each configured to alternate between a first size and a second size.

11. The grip adjustment system of claim 10, wherein the first size of the actuator corresponds to the first positon of the respective portion of the sleeve and the second size corresponds to the second position of the respective portion of the sleeve.

12. The grip adjustment system of claim 1, wherein each actuator comprises a microcontroller in communication with the processor.

13. The grip adjustment system of claim 12, wherein the microcontroller is configured to:
receive the actuation signal from the processor; and
transmit a stimulation signal to the actuator.

14. The grip adjustment system of claim 13, wherein the stimulation signal is an electric current.

15. The grip adjustment system of claim 1, wherein the optimal grip is determined using one selected from the range of:
Pearson correlation; and
Chi-squared analysis;
regression analysis;
artificial neural network analysis; and
decision tree analysis.

16. The grip adjustment system of claim 1, wherein the pressure distribution is determined using a grip analysis system comprising:
a sheath positionable, in use, on the object configured to be gripped by the user;
a distributed array of pressure sensors, each comprising an array position, arranged to detect the pressure distribution applied to the sheath; and
a processor operable to:
detect, with the array of pressure sensors, a grip of a user on the sleeve;
analyse the grip of the user on the sheath by:
receiving input data from the array of pressure sensors;
determining the pressure distribution corresponding to the grip of the user on the sheath based on the input data;
output the pressure distribution corresponding to the grip of the user on the sheath based on the input data.

17. The grip adjustment system of claim 16, wherein the pressure sensors are one or more selected from the range of:
a strain gauge;
a resistive pressure sensor;
a piezoelectric pressure sensor;
a pneumatic sensor;
a hydraulic sensor; and
a fiber bragg grating.

18. A grip adjustment method comprising the steps of:
receiving, from a remote server, a pressure distribution;
determining, with a processor, an optimal grip based on the pressure distribution;
selecting, with the processor, an actuator of a distributed array of actuators;
transmitting, with the processor, an actuation signal to the actuator;
actuating, with the actuator, a portion of a sleeve from a first position to a second position.

19. A grip analysis method comprising the steps of:
detecting, by an array of pressure sensors, a grip of a user on a sheath;
analysing the grip of the user on the sleeve by:
receiving input data from the array of pressure sensors;
determining a pressure distribution corresponding to the grip of the user on the sheath based on the input data; and
outputting the pressure distribution corresponding to the grip of the user on the sheath.
